(19) United States
(12) Patent Application Publication
(10) Pub. No.: US 2023/0177026 A1
(43) Pub. Date: Jun. 8, 2023

(54) DATA QUALITY SPECIFICATION FOR DATABASE

(71) Applicant: Microsoft Technology Licensing, LLC, Redmond, WA (US)

(72) Inventor: Kaushik PUSHPAVANAM, Sammamish, WA (US)

(73) Assignee: Microsoft Technology Licensing, LLC, Redmond, WA (US)

(21) Appl. No.: 17/457,880

(22) Filed: Dec. 6, 2021

(51) Int. Cl. G06F 16/215; G06F 16/26; G06F 11/07; G06F 3/0482

(52) U.S. Cl. CPC G06F 16/215; G06F 16/26; G06F 11/0769; G06F 3/0482

(57) ABSTRACT

A computing system including a processor configured to transmit, to a client computing device, a data quality specification prompt including a data quality specification template. The processor may receive a data quality specification from the client computing device. The data quality specification may be an at least partially filled copy of the data quality specification template and may include a data quality rule for entries included in a database. The data quality specification may further include a violation rate threshold for the data quality rule. The processor may store the data quality specification in memory. As specified by the data quality specification, the processor may determine that among the entries, a proportion of the entries exceeding the violation rate threshold violate the data quality rule. The processor may transmit a data quality rule violation notification to the client computing device.

### BACKGROUND

For users of database systems, it is frequently useful to assess the quality of data stored in a database. The quality of the data in the database may, for example, be determined by whether the entries included in a table are non-null, have an expected data type, and/or are within an expected range of values. Determining a level of data quality for the data stored in a database may allow the user to evaluate whether the data is sufficiently reliable to be used in decision-making. Determining the level of data quality may also allow the user to identify malfunctions or sources of error in systems from which the data is obtained.

### SUMMARY

According to one aspect of the present disclosure, a computing system is provided, including a processor configured to transmit, to a client computing device, a data quality specification prompt including a data quality specification template. The processor may be further configured to receive a data quality specification from the client computing device. The data quality specification may be an at least partially filled copy of the data quality specification template and may include a data quality rule for a plurality of entries included in a database. The data quality specification may further include a violation rate threshold for the data quality rule. The processor may be further configured to store the data quality specification in memory. As specified by the data quality specification, the processor may be further configured to determine that among the plurality of entries, a proportion of the entries exceeding the violation rate threshold violate the data quality rule. In response to determining that the proportion of the entries exceeding the violation rate threshold violate the data quality rule, the processor may be further configured to transmit a data quality rule violation notification to the client computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a data quality evaluation environment, according to one example embodiment.

FIG. 2 schematically shows a computing system and a client computing device at which at least a portion of the data quality evaluation environment may be instantiated, according to the example of FIG. 1.

FIG. 3 schematically shows a data quality specification including data quality expectations that may be specified by the data quality rule, according to the example of FIG. 1.

FIG. 4 shows an example of a first specification setting interface at which a first data quality specification template may displayed at a graphical user interface (GUI), according to the example of FIG. 1.

FIG. 5 schematically shows the computing system and the client computing device when the processor of the computing system is configured to receive a data quality expectation descriptor from the client computing device, according to the example of FIG. 1.

FIG. 6A shows an example of a second specification setting interface that may be displayed at the GUI in examples in which a prompt for a data quality expectation descriptor is transmitted to the client computing device, according to the example of FIG. 5.

FIG. 6B shows an example of a third specification setting interface including additional interface elements associated with a programmatically filled template, according to the example of FIG. 6A.

FIG. 7A shows an example first visual data quality representation that may be displayed at the GUI, according to the example of FIG. 1.

FIG. 7B shows an example second visual data quality representation that may be displayed at the GUI to show additional data quality information, according to the example of FIG. 7A.

FIG. 8 schematically shows the computing system during a runtime phase in an example in which the processor is configured to execute a data quality machine learning model, according to the example of FIG. 2.

FIG. 9 schematically shows the data quality machine learning model of FIG. 8 in additional detail.

FIG. 10 schematically shows the computing system during a training phase in which the processor is configured to train the data quality machine learning model, according to the example of FIG. 8.

FIG. 11 schematically shows the computing system when additional training is performed at the data quality machine learning model based at least in part on user feedback, according to the example of FIG. 8.

FIG. 12A shows a flowchart of an example method that may be used with a computing system when data quality evaluation is performed, according to the example of FIG. 1.

FIG. 12B shows additional steps of the method of FIG. 12A that may be performed when determining that a proportion of entries exceeding a violation rate threshold violate a data quality rule.

FIG. 13 shows alternative steps to those of FIG. 12A that may be performed when a data quality specification is generated, according to the example of FIG. 5.

FIG. 14A shows a flowchart of an example method that may be used with a computing system when training and executing a data quality machine learning model according to the example of FIG. 1.

FIG. 14B shows additional steps of the method of FIG. 14A that may be performed during a runtime phase in some examples.

FIG. 14C shows additional steps of the method of FIG. 14A that may be performed in some examples during each of a plurality of model parameter updating iterations.

FIG. 15 shows a schematic view of an example computing environment in which the computer system of FIG. 1 may be instantiated.

### DETAILED DESCRIPTION

According to previous methods of determining data quality, the user may write a query specifying a data quality rule in a domain-specific language. Writing such a query may be time-consuming and may require the user to have specialized programming knowledge. In another existing approach to generating data quality queries, the user enters data quality expectations at a query builder interface. However, existing query builder interfaces may also be slow and unintuitive to use for data quality assessment. Similarly to domain-specific languages, existing query builder interfaces may require specialized programming knowledge to use to determine data quality. Therefore, it may be difficult for a database system user to determine the quality of stored data.

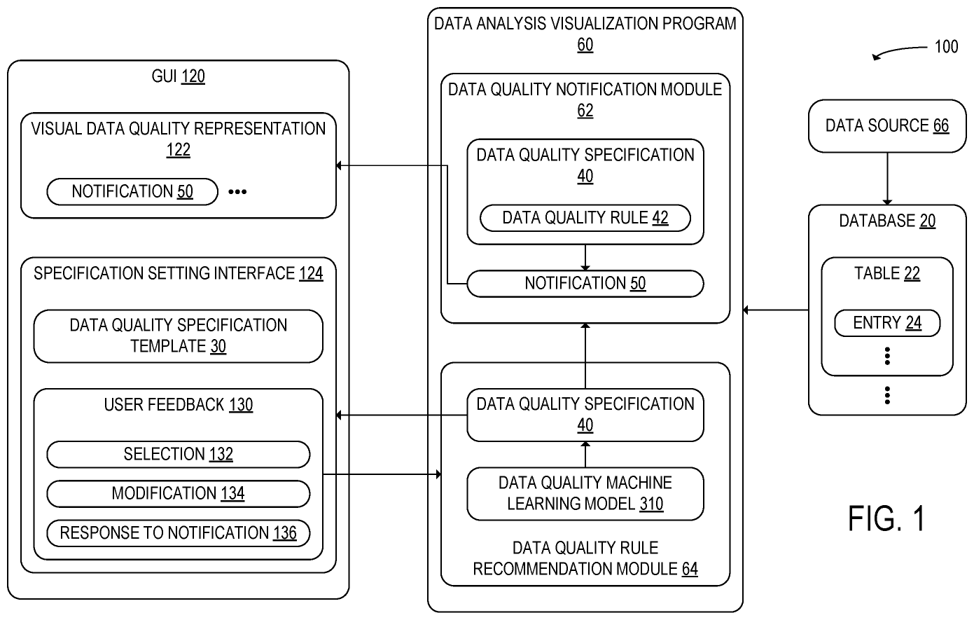

In order to address the above challenges, a data quality evaluation environment 100 is provided, as shown in the example of FIG. 1. The components of the data quality evaluation environment 100 are introduced with reference to FIG. 1 and discussed in further detail below. The data quality evaluation environment may be instantiated at one or more computing devices, which may include one or more server computing devices and one or more client computing devices. In the data quality evaluation environment, a database 20 is configured to store a plurality of entries 24 received from a data source 66. The database 20 may be a relational database, a non-relational database, or an object database. In some examples, as shown in FIG. 1, the database 20 may include a plurality of tables 22 into which the entries 24 are organized.

The data quality evaluation environment 100 may further include a data analysis visualization program 60 that is configured to generate and output a graphical user interface (GUI) 120. In addition, the data analysis visualization program 60 may be configured to receive user feedback 130 at the GUI 120, which may affect the behavior of the data analysis visualization program 60. At the data analysis visualization program 60, a visual data quality representation 122 of data quality assessments performed for the database 20 may be generated. The data analysis visualization program 60 may include a data quality notification module 62 at which a notification 50 may be generated when a data quality rule 42 included in a data quality specification 40 is violated.

In addition, the data analysis visualization program 60 may include a data quality rule recommendation module 64 that may be configured to generate the data quality specification 40 and convey the data quality specification 40 for display in graphical form at the GUI 120. The data quality specification 40 may, for example, be generated at least in part by executing a data quality machine learning model 310. In examples in which the data quality specification 40 is generated at least in part at the data quality rule recommendation module 64, the data quality specification 40 may include one or more programmatically generated data quality rules 42 that are suggested to the user at the GUI 120 and may be approved, modified, or rejected by the user.

The visual data quality representation 122 generated at the data analysis visualization program 60 may be displayed at the GUI 120. The visual data quality representation 122 may include a visual representation of the notification 50 that the data quality rule 42 has been violated. Other information related to data quality may also be displayed in the visual data quality representation 122, such as a failure rate for the data quality rule 42. The visual data quality representation 122 may, for example, include a plot or a table in which data quality information is displayed.

The GUI 120 may further include a specification setting interface 124 at which the user may define the data quality specification 40. The specification setting interface 124 may include a data quality specification template 30 that may be fillable by the user to define at least a portion of the data quality specification 40. The data quality specification template 30 may, for example, be selected at the data quality rule recommendation module 64. In addition, at the specification setting interface 124, the user may enter user feedback 130 when an output of the data quality rule recommendation module 64 is displayed. The user feedback 130 may, for example, include a selection 132 indicating to apply the data quality specification 40 generated at the data quality rule recommendation module 64. The user feedback 130 may additionally or alternatively include a modification 134 to the data quality specification 40. The user feedback 130 may also include, in some examples, a response to a notification 136 associated with a data quality rule 42 that is already implemented. The response to the notification 136 may, for example, be an instruction to increase or decrease the priority of the data quality rule 42 or to stop checking the data quality rule 42.

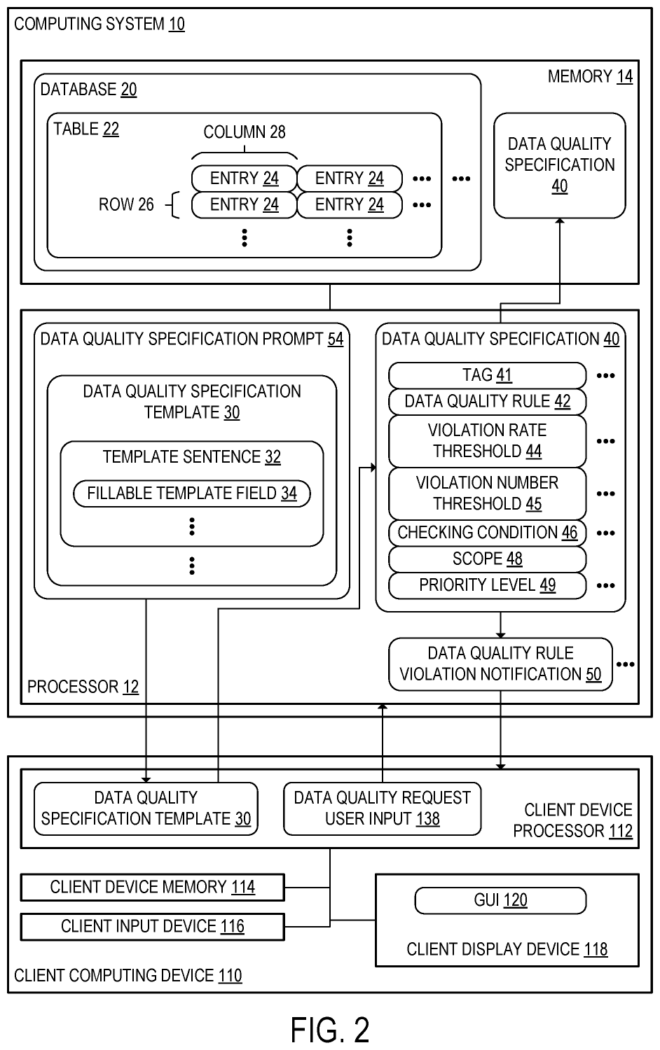

FIG. 2 schematically shows a computing system 10 and a client computing device 110 at which at least a portion of the data quality evaluation environment 100 may be instantiated. As shown in the example of FIG. 2, the computing system 10 may include a processor 12 and memory 14. The processor 12 may take the form of one or more physical processing devices, such as one or more central processing units (CPUs), graphical processing units (GPUs), field-programmable gate arrays (FPGAs), specialized hardware accelerators, or other types of processing devices. The memory 14 may take the form of one or more physical memory devices, which may include volatile memory such as random-access memory (RAM) and may further include non-volatile storage (e.g. disk storage). In some examples, the processor 12 and the memory 14 may be integrated into a single physical component, such as a system-on-a-chip (SoC). Although the processor 12 and the memory 14 are shown in FIG. 2 within a single physical computing device, the functionality of the processor 12 and/or the memory 14 may be distributed across a plurality of communicatively coupled physical computing devices in other examples. The plurality of physical computing devices may, for example, be a plurality of server computing devices located in a data center.

The client computing device 110 may include a client device processor 112 and client device memory 114. Similarly to the processor 12 and the memory 14 of the computing system 10, the client device processor 112 and the client device memory 114 may each be instantiated in one physical processing device or physical memory device, respectively, or may alternatively be provided across a plurality of physical components. The client computing device 110 may further include one or more client input devices 116 and one or more client display devices 118. The client computing device 110 may be configured to receive the user feedback 130 via the one or more client input devices 116. The GUI 120 may be displayed at the one or more client display devices 118. In some examples, the client computing device 110 may include one or more other output devices in addition to the one or more client display devices 118.

As depicted in the example of FIG. 2, the database 20 may be stored in the memory 14 of the computing system 10. The database 20 may include one or more tables 22. As shown in FIG. 2, the database 20 may be a relational database in which the plurality of entries 24 included in a table 22 are organized into a plurality of rows 26 and a plurality of columns 28. In other examples, the database 20 may be a non-relational database or an object database.

The processor 12 of the computing system 10 may be configured to transmit, to the client computing device 110, a data quality specification prompt 54 including a data quality specification template 30. The data quality specification prompt 54 may be a prompt for the user to enter data quality expectations for the data included in the database 20. The data quality specification template 30 may be configured to be displayed at the GUI 120 of the client computing device 110. Accordingly, after the processor 12 has transmitted the data quality specification prompt 54 to the client computing device 110, the data quality specification template 30 may be displayed at the GUI 120 in the specification setting interface 124.

In some examples, the data quality specification template 30 may include a plurality of template sentences 32 that are configured to be selectable at the GUI 120 of the client computing device 110. Thus, the user may select a template sentence 32 that most closely matches the structure of the user's data quality expectation. The user may select two or more of the template sentences 32 when the user has two or more data quality expectations for the plurality of entries 24. The user of the client computing device 110 may fill the one or more fillable template fields 34 of the data quality specification template 30 by interacting with the GUI 120. Thus, in such examples, the data quality specification 40 may include a filled version of a template sentence 32 of the plurality of template sentences 32. In some examples, as discussed in further detail below, at least one fillable template field 34 may be pre-filled at the data quality rule recommendation module 64 prior to transmitting the data quality specification prompt 54 to the client computing device 110.

Subsequently to transmitting the data quality specification prompt 54 to the client computing device 10, the processor 12 may be further configured to receive the data quality specification 40 from the client computing device 110. The data quality specification 40 may be an at least partially filled copy of the data quality specification template 30 in which at least one fillable template field 34 has been filled. In some examples, the data quality specification 40 received from the client computing device 110 may include at least one fillable template field 34 that is left unfilled. In such examples, the processor 12 may be further configured to programmatically generate, at the data quality rule recommendation module 64, a value with which to fill the at least one unfilled field.

The data quality specification template 30 may include a data quality rule 42 for the plurality of entries 24 included in the database 20. In some examples, rather than pertaining to the entire database 20, the data quality rule 42 may be applied to a subset of the database 20, such as a specific table 22 or one or more specific rows 26 or columns 28. Thus, the plurality of entries 24 for which the data quality rule 42 is specified may be only a subset of all the entries 24 included in the database 20. In such examples, the data quality specification 40 may further include a scope 48 of the data quality rule 42 that indicates the subset of the database 20 for which the processor 12 is configured to check the data quality rule 42.

The data quality specification may further include a violation rate threshold 44 for the data quality rule 42. The violation rate threshold 44 may be a violation rate for the data quality rule 42 at which a data quality rule violation notification 50 is configured to be transmitted to the client computing device 110. The violation rate threshold 44 may be expressed as a proportion of the plurality of entries 24. In some examples, additionally or alternatively to the violation rate threshold 44, the data quality specification may include a violation number threshold 45 expressed as an absolute number of violations.

The processor 12 may be further configured to store the data quality specification 40 in the memory 14. The data quality specification 40 may, for example, be stored in the memory 14 in response to receiving, from the client computing device 110, a selection 132 of the data quality rule 42 for application to the plurality of entries 24. Subsequently to storing the data quality specification 40, the processor 12 may be further configured to check the plurality of entries 24 for violations of the data quality rule 42 as specified by the data quality specification 40. The processor 12 may, for example be configured to check for violations of the data quality rule 42 according to a predefined schedule or when a specific action is performed at the database 20, as discussed in further detail below. The processor 12 may be configured to determine that among the plurality of entries 24, a proportion of the entries 24 exceeding the violation rate threshold 44 violate the data quality rule 42. In examples in which the data quality specification includes a violation number threshold 45, the processor 12 may be further configured to determine that a number of violations of the data quality rule 42 exceeding the violation number threshold 45 have occurred.

In response to determining that the proportion of the entries 24 exceeding the violation rate threshold 44, or that a number of entries exceeding the violation number threshold 45, violate the data quality rule 42, the processor 12 may be further configured to transmit a data quality rule violation notification 50 to the client computing device 110. The data quality rule violation notification 50 may be configured to be displayable at the GUI 120, as discussed above. Thus, the processor 12 may be configured to notify the user that the data quality rule 42 has been violated at a rate or number exceeding the violation rate threshold 44 or violation number threshold 45. The user may accordingly take an action informed by the notification 50 to identify a source of the violations or decrease the violation rate.

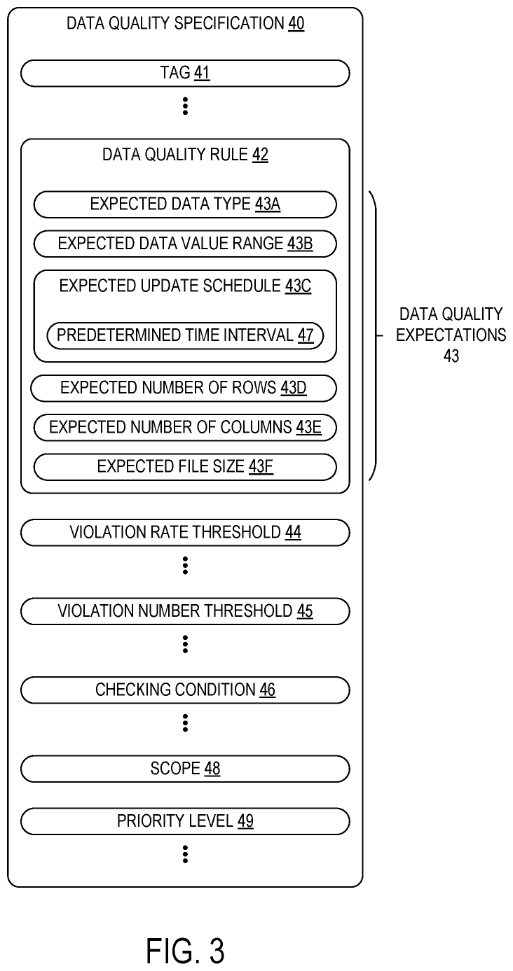

FIG. 3 schematically shows the data quality specification 40 in additional detail, including a plurality of data quality expectations 43 that may be specified by the data quality rule 42. For example, the data quality rule 42 may include, as the data quality expectation 43, an expected data type 43A for the plurality of entries 24, an expected data value range 43B for the plurality of entries 24, an expected update schedule 43C for the plurality of entries 24, an expected number of rows 26 of the table 22 that includes the plurality of entries 24, an expected number of columns 28 of the table 22, or an expected file size 43F of the table 22. In other examples, the data quality rule 42 may include some other type of data quality expectation 43.

In examples in which the data quality rule 42 includes an expected update schedule 43C, the processor 12 may be further configured to determine, at a predetermined time interval 47 specified by the expected update schedule 43C, whether the proportion of the entries 24 that violate the data quality rule 42 exceeds the violation rate threshold 44. Thus, for example, the processor 12 may be configured to determine whether a table 22 that is expected to be updated at a regular time interval has been updated on schedule.

In some examples, the processor 12 may be further configured to receive a data quality request user input 138 from the client computing device 110. The data quality request user input 138 may be a request to check for violations of the data quality rule 42. In response to receiving the data quality request user input 138, the processor 12 may be further configured to determine whether the proportion of the entries 24 that violate the data quality rule 42 exceeds the violation rate threshold 44. Thus, the user may instruct the processor 12 to determine whether the entries 24 violate the data quality rule 42.

In some examples, the data quality specification 40 may further include a checking condition 46 for the data quality rule 42 that indicates a specific modification or type of modification that may be performed at the database 20. For example, the checking condition 46 may be a condition in which one or more new entries 24 are added to the database 20; an amount of data exceeding a predetermined size is added to the database 20; a specific table 22, row 26, or column 28 is modified; or a new table 22, row 26, or column 28 is added. When a modification to the database 20 is performed, the processor 12 may be further configured to determine that the modification to the database 20 satisfies the checking condition 46. In response to determining that the modification satisfies the checking condition 46, the processor 12 may be further configured to determine whether the proportion of the entries 24 that violate the data quality rule 42 exceeds the violation rate threshold 44. Accordingly, the processor 12 may be configured to check for violations of the data quality rule 42 when an action is performed on the database 20 that may be likely to result in violation of the data quality rule 42.

In some examples, the violation rate threshold 44 may be included among a plurality of differing violation rate thresholds 44 for the data quality rule 42. The plurality of differing violation rate thresholds 44 may indicate different severity levels of violation of the data quality rule 42. When the processor 12 generates the data quality rule violation notification 50, the data quality rule violation notification 50 may be selected from among a plurality of data quality rule violation notifications 50 respectively associated with the violation rate thresholds 44. Thus, the data quality rule violation notification 50 may be selected as specified by which violation rate threshold 44 is exceeded.

Similarly, when the data quality specification 40 includes a violation number threshold 45 for the data quality rule 42, the data quality specification 40 may include a plurality of differing violation number thresholds 45 for the data quality rule 42 that indicate different violation severity levels. A data quality rule violation notification 50 generated when the number of entries 24 that violate the data quality rule 42 exceeds a violation number threshold 45 may also be selected according to which of the plurality of violation number thresholds 45 is exceeded.

In examples in which the data quality specification 40 includes a plurality of different violation rate thresholds 44, the data quality specification 40 may further include a respective plurality of priority levels 49 of the data quality rule violation notifications 50 associated with the violation rate thresholds 44. The plurality of priority levels 49 may differ among the plurality of data quality rule violation notifications 50. For example, the plurality of priority levels 49 may include a “warning” priority level and an “alert” priority level. Thus, the priority level 49 of the data quality rule violation notification 50 that is output when a data quality rule 42 is violated may be determined by the severity of the violation, as indicated by which of the violation rate thresholds 44 is surpassed. Data quality rule violation notifications 50 with different priority levels 49 may be displayed differently at the GUI 120. In examples in which the data quality specification 40 includes a plurality of different violation number thresholds 45, the data quality rule violation notifications 50 associated with those violation number thresholds 45 may also have a respective plurality of differing priority levels 49.

In some examples, a plurality of different data quality rules 42 may be applied to the plurality of entries 24. The respective scopes 48 of the plurality of data quality rules 42 may be the same or may alternatively be only partially overlapping. The plurality of data quality rules 42 may have a respective plurality of priority levels 49. Thus, differences in priority may be specified between different data quality rules 42, additionally or alternatively to between different levels of violation severity for a particular data quality rule 42.

As discussed in further detail below, the data quality specification 40 may further include one or more tags 41 that may be used as metadata for the data quality specification 40. The one or more tags 41 may, for example, be included in a header of the data quality specification 40.

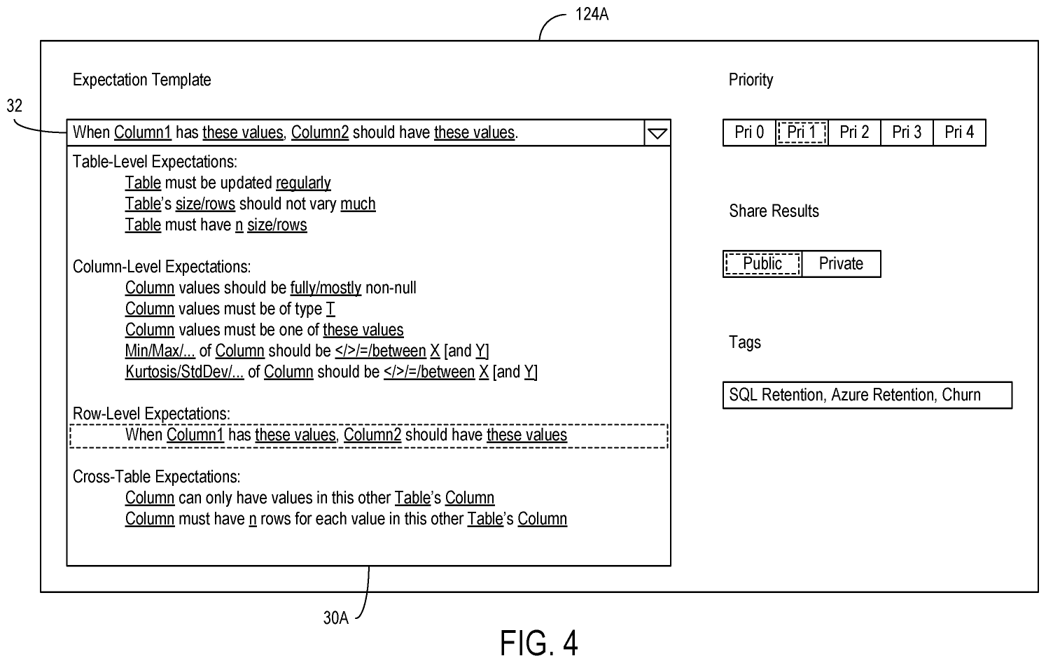

FIG. 4 shows an example of a first specification setting interface 124A at which a first data quality specification template 30A is displayed. In the first data quality specification template 30A shown in the example of FIG. 4, the underlined words indicate fillable fields. The first data quality specification template 30A includes a plurality of template sentences 32 from among which the user may select the template sentence 32 that is used to generate the data quality specification 40. In the example of FIG. 4, the selected template sentence 32 is “When [Column1] has [these values], [Column2] should have [these values].” The fillable template fields [Column1] and [Column2] may be filled with column numbers or headers of two columns 28 of the table 22. The fillable fields [these values] may each be filled with discrete values or ranges of values that the entries 24 in the columns 28 are expected to have.

In the first data quality specification template 30A shown in FIG. 4, the template sentences 32 are sorted into table-level expectations, column-level expectations, row-level expectations, and cross-table expectations. Within each of the above categories, the template sentences 32 are organized in a ranked list according to estimated probability of adoption by the user, as discussed in further detail below. In other examples, the plurality of template sentences 32 may be ranked according to some other criterion.

The first specification setting interface 124A shown in FIG. 4 further indicates a plurality of priority levels 49 from among which the user may select a priority level 49 for the data quality rule 42. In addition, the first specification setting interface 124A includes an interface element at which the user may select a sharing setting for data quality rule violation notifications 50 within the user's organization.

The first specification setting interface 124A further includes an interface element at which the user may specify one or more tags associated with the data quality rule 42. In some examples in which a plurality of data quality rules 42 are applied to the plurality of entries 24 included in the database 20, the processor 12 may be configured to receive a plurality of data quality specifications 40 that each include one or more tags 41. The processor 12 may be further configured to store the plurality of data quality specifications 40 in the memory 14. Subsequently to storing the plurality of data quality specifications 40, the processor 12 may be further configured to receive, from the client computing device 110, a selection of a tag 41 of the one or more tags 41. In response to receiving the selection of the tag 41, the processor 12 may be configured to determine, for each of the plurality of data quality specifications 40 that have the selected tag 41, whether the proportion of the entries 24 that violate the data quality rule 42 for that data quality specification 40 exceeds the violation rate threshold 44 for that data quality rule 42. Thus, the tags 41 included in the data quality specifications 40 may allow the user to perform a bulk operation to check for violations of a plurality of data quality rules 42 by selecting a tag 41 associated with those data quality rules 42.

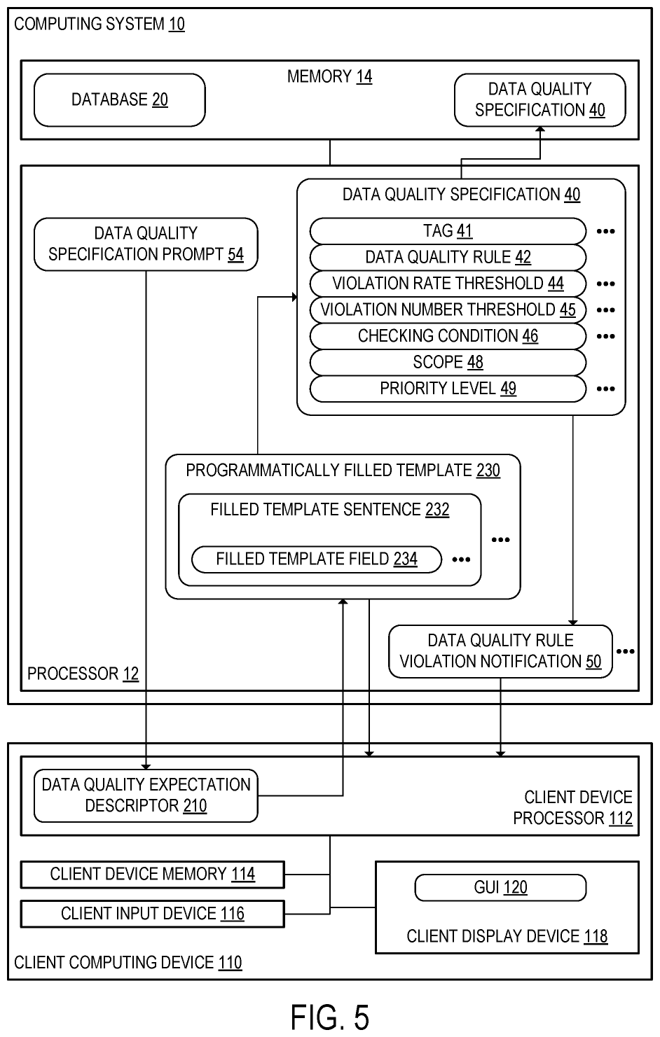

In some examples, as schematically shown in FIG. 5, the processor 12 may be configured to receive a data quality expectation descriptor 210 from the client computing device 110 in the form of a natural language statement. The data quality expectation descriptor 210 may be received from the client computing device 110 instead of a data quality specification template 30 in response to transmitting the data quality specification prompt 54 to the client computing device 110. Subsequently to receiving the data quality expectation descriptor 210, the processor 12 may be further configured to generate the data quality specification 40 based at least in part on the data quality expectation descriptor 210. When generating the data quality specification 40 from the data quality expectation descriptor 210, the processor 12 may be configured to generate a programmatically filled template 230 based at least in part on the data quality expectation descriptor 210. The programmatically filled template 230 may include one or more filled template sentences 232, each of which may include one or more filled template fields 234. The processor 12 may be further configured to transmit the programmatically filled template 230 to the client computing device 110 for approval, modification, or rejection. The processor 12 may be further configured to generate the data quality specification 40 from the programmatically filled template 230, subsequently to any modifications to the programmatically filled template made by the user of the client computing device 110.

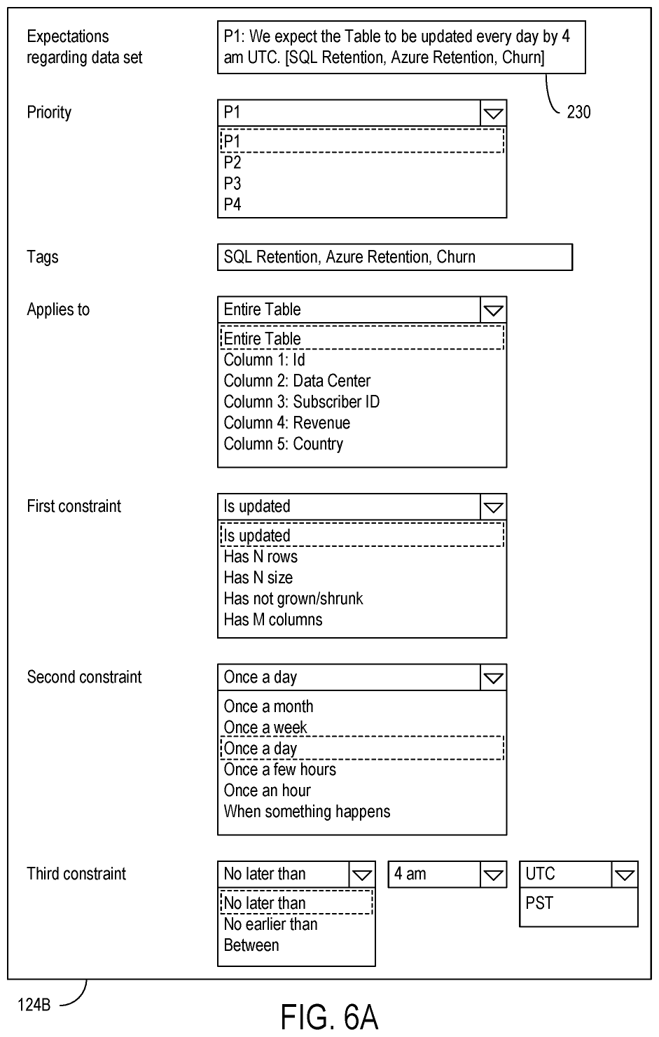

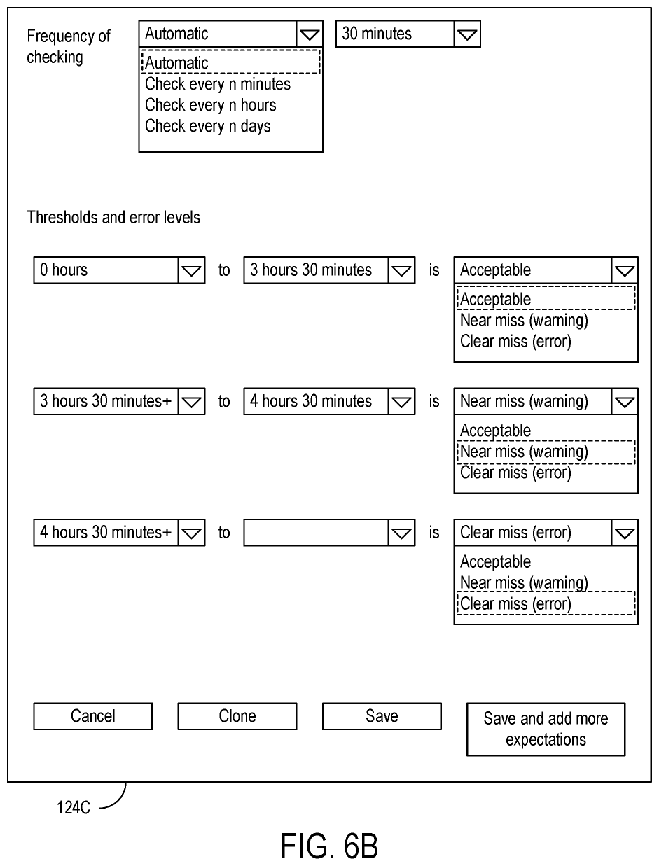

FIG. 6A shows an example of a second specification setting interface 124B that may be displayed at the GUI 120 in examples in which the data quality specification prompt 54 is a prompt for a data quality expectation descriptor 210 in the form of a natural language statement. In the example of FIG. 6A, the programmatically filled template 230 is displayed at the second specification setting interface 124B after the user has entered the natural language statement. The programmatically filled template 230 includes an expected update schedule 43C for a plurality of entries 24. At the second specification setting interface 124B, the user may modify one or more portions of the programmatically filled template 230 by interacting with the GUI 120. In addition, the user may assign one or more tags 41 and a priority level 49 to the data quality specification 40 that is generated from the programmatically filled template 230.

FIG. 6B shows an example of a third specification setting interface 124C including additional interface elements associated with the programmatically filled template 230 of the second specification setting interface 124B. In some examples, the second specification setting interface 124B and the third specification setting interface 124C may be displayed concurrently at the GUI 120. At the third specification setting interface 124C, the user may select a frequency with which the data quality rule 42 is checked for violation. In addition, the user may set respective priority levels 49 for different amounts by which the expected update time indicated in the expected update schedule 43C may be exceeded. The different overshoot amounts for the expected update time may, for example, be expressed in the data quality specification 40 as a plurality of violation number thresholds 45.

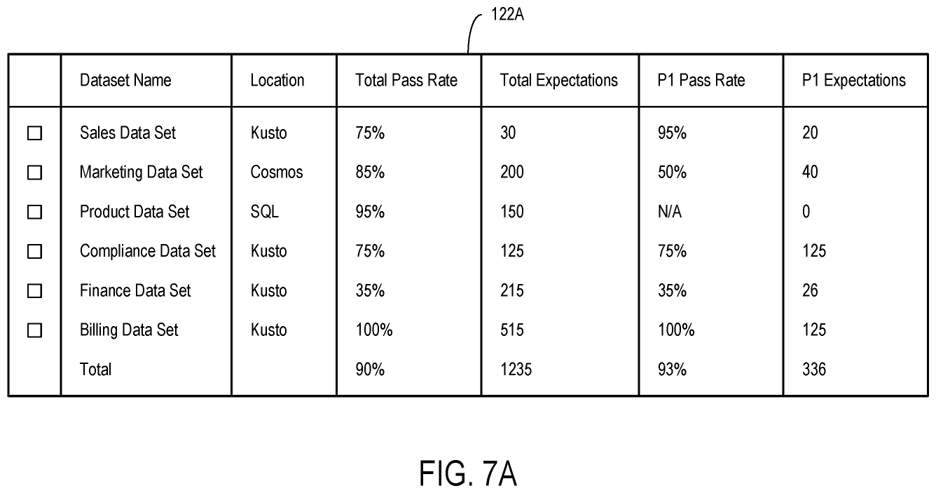

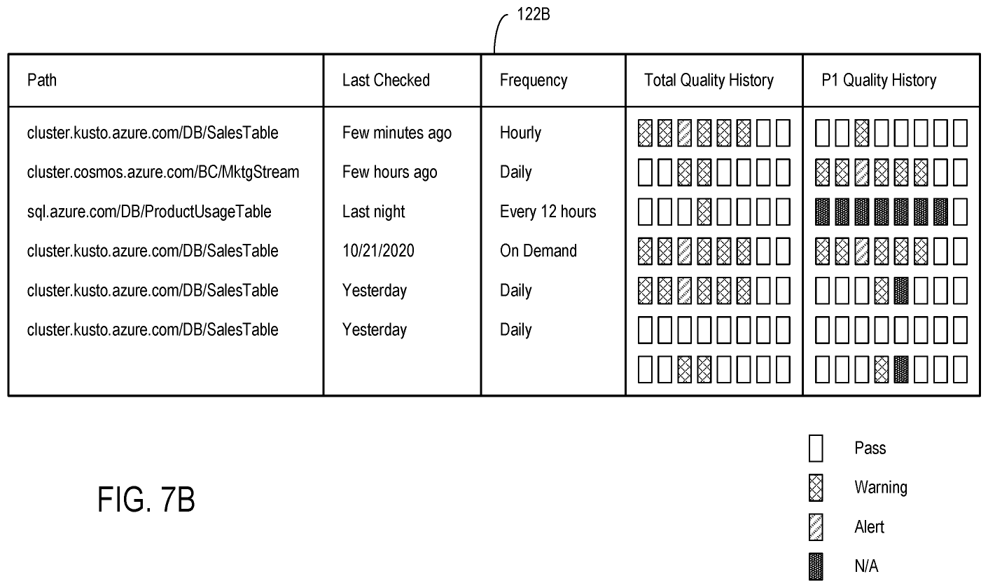

FIG. 7A shows an example first visual data quality representation 122A that may be displayed at the GUI 120. As depicted in FIG. 7A, the first visual data quality representation 122A includes a table that displays the names of a plurality of datasets for which data quality expectations have been defined. The first visual data quality representation 122A further indicates respective locations at which the datasets are stored. For the data quality rules 42 defined for each dataset, the first visual data quality representation 122A further includes columns that indicate a total pass rate, a total number of data quality rules 42, a pass rate for priority 1 data quality rules 42, and a total number of priority 1 data quality rules 42.

FIG. 7B shows an example second visual data quality representation 122B that may be displayed at the GUI 120 and may show additional data quality information for the datasets of FIG. 7A. The second visual data quality representation 122B of FIG. 7B shows a file path to each of the datasets of FIG. 7A. In addition, for each of the datasets, the second visual data quality representation 122B shows a time at which the data quality rules 42 for that dataset were last checked for violations and a frequency with which the data quality rules 42 for that dataset are configured to be checked. The second visual data quality representation 122B further includes columns indicating the results of a plurality of the most recent data quality rule checks for each of the datasets, with respective columns for total quality history and priority 1 quality history.

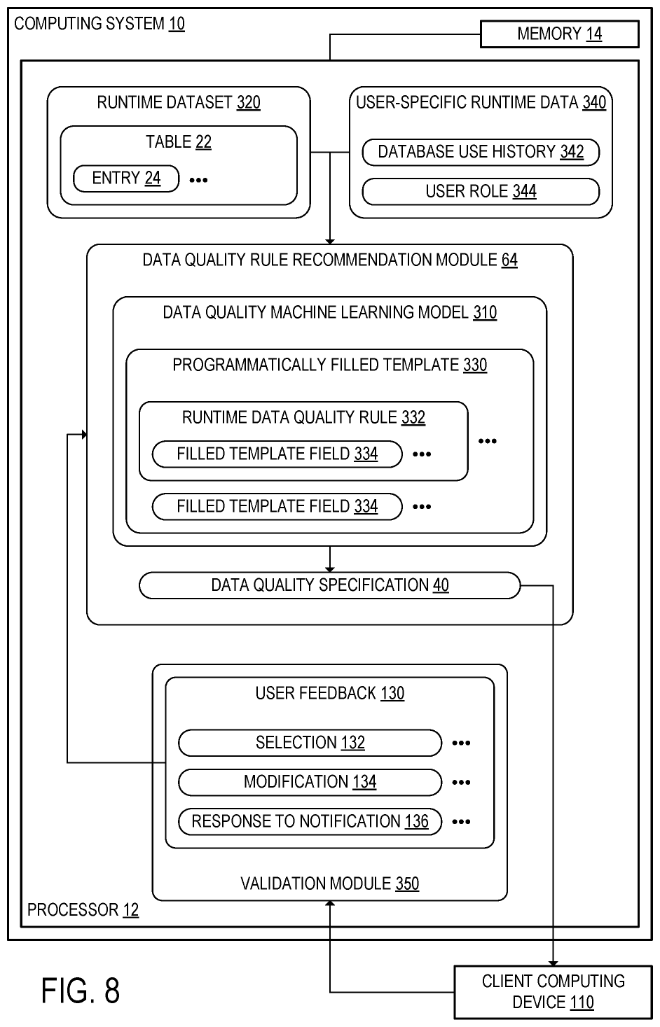

As discussed above, the data quality specification 40 may, in some examples, be generated at least in part at a data quality machine learning model 310. FIG. 8 schematically shows the computing device 10 during a runtime phase in an example in which the processor 12 is configured to execute the data quality machine learning model 310. In the example of FIG. 8, the processor 12 is configured to execute the data quality machine learning model 310 when executing a data quality rule recommendation module 64. The processor 12 may be configured to receive, as an input to the data quality rule recommendation module 64, a runtime dataset 320 including a plurality of runtime entries. In the example of FIG. 8, the plurality of runtime entries are the entries 24 shown in FIG. 1. In addition, the processor 12 may be further configured to receive user-specific runtime data 340 as an input to the data quality rule recommendation module 64. The user-specific runtime data 340 may, for example, include database use history 342 for the user that indicates one or more prior operations performed by the user at the database 20. Additionally or alternatively, the user-specific runtime data 340 may include a user role 344 within an organization with which the user is affiliated. The user role 344 may, for example, be indicated in terms of a title of the user within the organization or a position of the user in a social graph of the organization. Other types of user-specific runtime data 340 may additionally or alternatively be used as inputs to the data quality rule recommendation module 64 in other examples.

The processor 12 may be further configured to execute the data quality machine learning model 310 to generate a runtime data quality rule 332 for the runtime dataset 320. The runtime data quality rule 332 may be included in a programmatically filled template 330 that is generated at the data quality machine learning model 310 based at least on the runtime dataset 320 and, in examples in which the user-specific runtime data 340 is also received at the data quality rule recommendation module 64, the user-specific runtime data 340. The runtime data quality rule 332 may include one or more filled template fields 334 that are filled with values generated at the data quality machine learning model 310. The runtime data quality rule 332 may, for example, include an expected data type 43A for the plurality of runtime entries 24, an expected data value range 43B for the plurality of runtime entries 24, an expected update schedule 43C for the plurality of runtime entries 24, an expected number of rows 43D of a table 22 that includes the plurality of runtime entries 24, an expected number of columns 43E of the table 22 that includes the plurality of runtime entries 24, or an expected file size 43F of the table 22 that includes the plurality of runtime entries 24.

The programmatically filled template 330 may further include one or more additional filled template fields 334 for one or more additional properties of the data quality specification 40. For example, the programmatically filled template 330 may include a filled template field 334 corresponding to a violation rate threshold 44 or a violation number threshold 45 for the runtime data quality rule 332. The programmatically filled template 330 may, in some examples, further include one or more filled template fields 334 indicating one or more tags 41 for the data quality specification 40.

Subsequently to generating the data quality specification 40, the processor 12 may be further configured to transmit a graphical representation of the data quality specification 40 to the client computing device 110. The graphical representation of the data quality specification 40 may include an indication of the runtime data quality rule 332 with the one or more filled template fields 334.

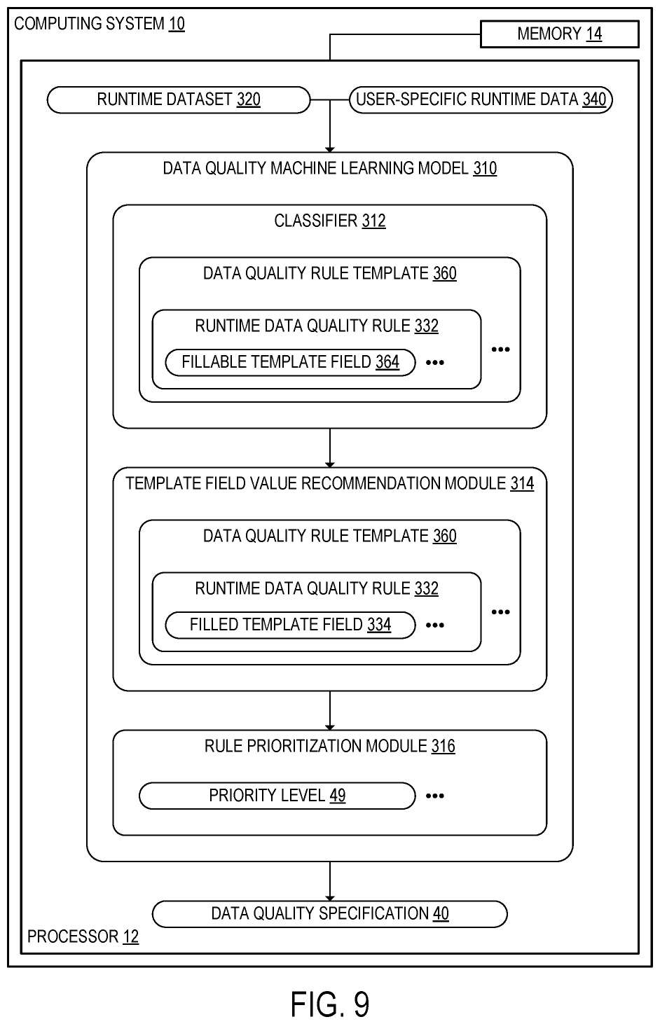

FIG. 9 shows the data quality machine learning model 310 in additional detail, according to one example. As shown in the example of FIG. 9, the data quality machine learning model 310 may include a plurality of sub-modules, which may be a plurality of neural networks that are configured to perform separate processing stages that occur when the processor 12 generates the data quality specification 40. In other examples, the data quality machine learning model 310 may be provided as a single neural network.

As shown in FIG. 9, the data quality machine learning model 310 may include a classifier 312. When the classifier 312 receives inputs including the runtime dataset 320 and, in some examples, the user-specific runtime data 340, the classifier 312 may be configured to select a data quality rule template 360 for the runtime data quality rule 332 from among a plurality of data quality rule templates 360 based at least on the received inputs. Each data quality rule template 360 may include one or more fillable template fields 364. In some examples, the processor 12 may be configured to generate a ranked list of the plurality of data quality rule templates 360 at the classifier 312. The plurality of data quality rule templates 360 may be ranked according to estimated probabilities that the user will select, for application to the runtime dataset 320, corresponding runtime data qualities rules 332 generated by filling the data quality rule templates 360.

In addition to the classifier, the data quality machine learning model 310 may further include a template field value recommendation module 314. At the template field value recommendation module 314, the processor 12 may be further configured to programmatically generate values with which the one or more fillable template fields 364 are filled. Thus, the template field value recommendation module 314 may be configured to receive the one or more data quality rule templates 360 as inputs and to output filled versions of the one or more data quality rule templates 360.

As shown in FIG. 9, the data quality machine learning model 310 may further include a rule prioritization module 316 at which the processor 12 is configured to generate a priority level 49 for each runtime data quality rule 332. The rule prioritization module 316 may, for example, be an additional classifier configured to select the corresponding priority level 49 for each runtime data quality rule 332 from among a plurality of priority levels 49.

Returning to the example of FIG. 8, the processor 12 may be further configured to execute a validation module 350 at which updates to the data quality specification 40 may be made based at least in part on user feedback 130. The user feedback 130 may indicate whether the user applied the runtime data quality rule 332 to the runtime dataset 320. As discussed above, the user feedback 130 may include a selection 132 of a recommended runtime data quality rule 332 for application to the runtime dataset 320. The user feedback 130 may further include a modification 134 made to the runtime data quality rule 332 at the GUI 120. The modification 134 may be made prior to applying the runtime data quality rule 332. Additionally or alternatively, the modification 134 may be made subsequently to applying the runtime data quality rule 332 during a phase in which the runtime data quality rule 332 is configured to be checked at a predetermined time interval 47.

The user feedback 130 may further include one or more responses to notifications 136. The one or more responses to notifications 136 may indicate actions taken by the user in response to the processor 12 transmitting one or more corresponding data quality rule violation notifications 50 to the client computing device 110. For example, a response to a notification 136 may include instructions to update the database 20, modify the data quality rule 42 with which the data quality rule violation notification 50 is associated, or stop checking the data quality rule 42. The response to the notification 136 may alternatively indicate the user has ignored the data quality rule violation notification 50. Other types of responses to notifications 136 may additionally or alternatively be received at the validation module 350.

The processor 12 may be further configured to programmatically modify the data quality specification 40 at the validation module 350 subsequently to receiving the user feedback 130. For example, the processor 12 may be configured to apply a modification 134 received from the client computing device 110. As another example, when a response to a notification 136 includes instructions to update the database 20, the processor 12 may be further configured to increase the priority level 49 of the runtime data quality rule 332, and when the user does not respond to the data quality rule violation notification 50, the processor 12 may be further configured to decrease the priority level 49.

In some examples, when the processor 12 executes the validation module 350, the processor 12 may be configured to modify the data quality specification 40 based at least in part on one or more inputs other than the user feedback 130. For example, when the runtime data quality rule 332 is checked at a predetermined time interval 47, the processor 12 may be configured to increase the predetermined time interval 47 in response to determining that the violation rate of the runtime data quality rule 332 has been below the violation rate threshold for more than a threshold number of consecutive predetermined time intervals 47. In another example, the processor 12 may be configured to consolidate a large number of data quality rule violation notifications 50 into a smaller number of data quality rule violation notifications 50 when the number of data quality rule violation notifications 50 is above a threshold number or the rate at which the data quality rule violation notifications 50 are generated is above a threshold rate. The instructions to consolidate the plurality of data quality rule violation notifications 50 may be indicated among the one or more violation rate thresholds 44 or the one or more violation number thresholds 45 in such examples.

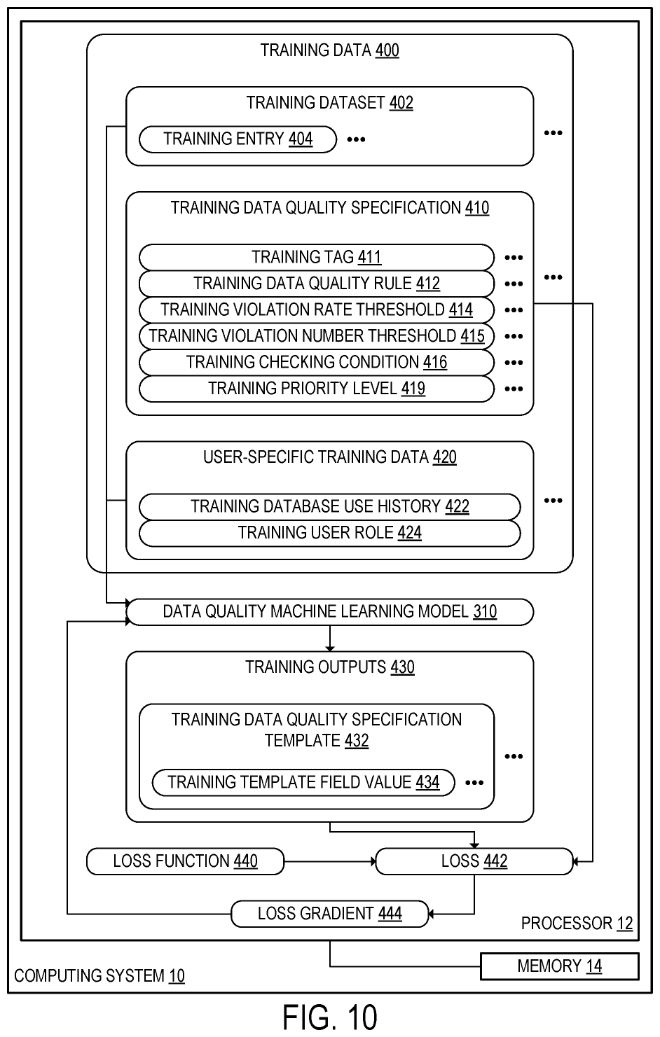

FIG. 10 schematically depicts, according to one example, the computing system 10 during a training phase in which the processor 12 is configured to train the data quality machine learning model 310. It will be appreciated that the training phase and runtime phase may be executed on different processors, such that one or more processors execute the combined training phase and runtime phase describe herein. During the training phase, the processor 12 may be configured to receive training data 400 including a plurality of training datasets 402. The training datasets 402 may each include a plurality of training entries 404. Each training dataset 402 may be at least a portion of a database. In addition, the training data 400 may further include a plurality of training data quality rules 412 respectively associated with the training datasets 402. The plurality of training data quality rules 412 may be received from a plurality of users that may or may not include the runtime-phase user of the data quality machine learning model 310.

In some examples, the training data 400 may further include, for each training data quality rule 412 of the plurality of training data quality rules 412, respective user-specific training data 420 associated with a user from whom the training data quality rule 412 is received. The user-specific training data 420 may include database use history 422 of the user. The database use history 424 may indicate the user's use history of the database from which the corresponding training dataset 402 is excerpted. Additionally or alternatively, the user-specific training data 420 may include a user role indicator 424 of the user that indicates the role of the user within an organization.

In some examples, when the processor 12 receives the plurality of training data quality rules 412, the training data quality rules 412 may be included in a plurality of training data quality specifications 410 that further include additional information. The additional information may include one or more training tags 411, one or more training violation rate thresholds 414, one or more training violation number thresholds 415, one or more training checking conditions 416, and/or one or more training priority levels 419 for each training data quality rule 412. In examples in which the training data 400 includes a plurality of training data quality specifications 410, the plurality of training data quality specifications 410 may each be paired with respective training datasets 402, and, in some examples, respective user-specific training data 420. In addition, one or more of the training data quality specifications 410 may include two or more training data quality rules 412.

Using the plurality of training data quality rules 412, the corresponding plurality of training datasets 402, and, in some examples, the corresponding plurality of user-specific training data 420, the processor 12 may be further configured to perform a respective plurality of model parameter updating iterations at the data quality machine learning model 310. The data quality machine learning model 310 may be configured to receive the plurality of training datasets 402 and, in some examples, the plurality of user-specific training data 420 as inputs. The training data quality rules 412 may be compared to training outputs 430 of the data quality machine learning model 310 during the plurality of model parameter updating iterations as discussed below.

During each model parameter updating iteration, the processor 12 may be configured to generate a training output 430 at the data quality machine learning model 310 based at least in part on a training dataset 402 of the plurality of training datasets 402. Each training output 430 may include a training data quality specification template 432 with one or more training template field values 434. The data quality machine learning model 310 may, for example, be configured to select the training data quality specification template 432 from among a plurality of candidate templates. The processor 12 may be further configured to generate the one or more training template field values 434 to fill one or more respective fillable fields in the selected template. In examples in which the training data 400 includes a plurality of training data quality specifications 410 that include additional data associated with the plurality of training data quality rules 412, the training template field values 434 included in the training data quality specification template 432 may further include estimated output values for that additional data.

During each model parameter updating iteration included in the training phase, the processor 12 may be further configured to compute a loss 442 for the data quality machine learning model 310 using a loss function 440. The loss function 440 may take the plurality of training data quality rules 412 and the plurality of training outputs 430 as inputs, such that each value of the loss 442 is computed based at least in part on a training output 430 of the plurality of training outputs 430 and a corresponding training data quality rule 412 of the plurality of training data quality rules 412. In examples in which the training data quality rules 412 are included in a plurality of training data quality specifications 410, the loss function 440 may take the training data quality specifications 410 and the training outputs 430 as inputs. The processor 12 may be further configured to compute a loss gradient 444 of the data quality machine learning model 310 based at least in part on the loss 442 and to update the parameters of the data quality machine learning model 310 by performing gradient descent using the loss gradient 444. Accordingly, the data quality machine learning model 310 may be trained over the plurality of model parameter updating iterations.

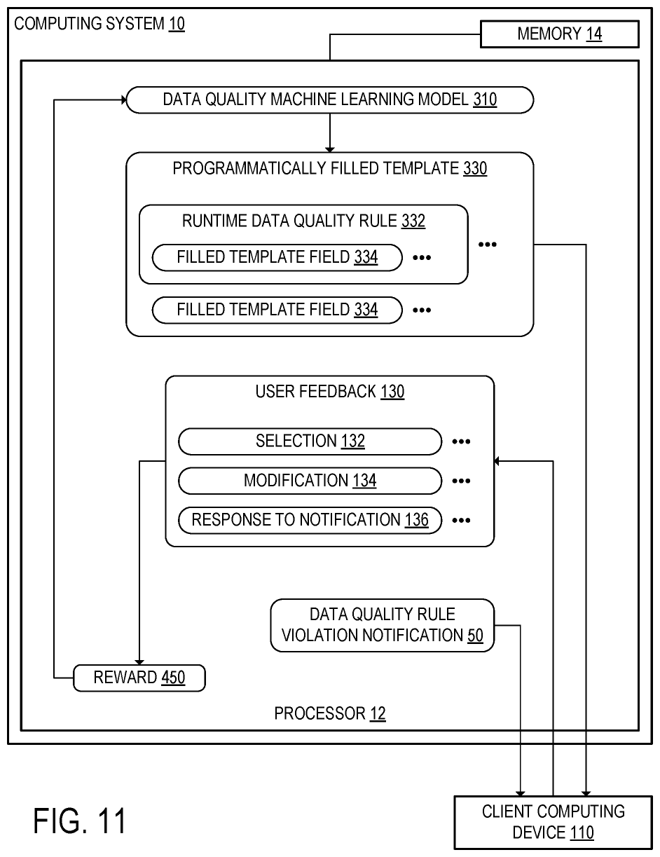

In some examples, as shown in FIG. 11, additional training may be performed at the data quality machine learning model 310 based at least in part on the user feedback 130 received during the runtime phase. For example, the processor 12 may be configured to implement a reinforcement learning algorithm in which a reward 450 is computed based at least in part on the user feedback 130. The processor 12 may be further configured to update the parameters of the data quality machine learning model 310 based at least in part on the reward 450.

Values of the reward 450 may be respectively associated with the programmatically filled templates 330 generated at the data quality machine learning model 310. For example, the reward 450 associated with a programmatically filled template 330 may be maximized when the processor 12 receives a selection 132 of the programmatically filled template 330 for application to the runtime dataset 320 with no modifications. The reward 450 may be reduced when the user makes one or more modifications 134 to the programmatically filled template 330.

Values of the reward 450 may also be associated with responses to notifications 136 received at the processor 12 subsequently to transmitting data quality rule violation notifications 50 to the client computing device 110. For example, the reward 450 associated with a response to a notification 136 may have a high value when the user responds to the corresponding data quality rule violation notification 50 by making a modification to the database 20. The reward 450 may have a lower value when the user takes no action in response to receiving the data quality rule violation notification 50 or when the user marks the data quality rule violation notification 50 as unneeded or spurious at the GUI 120.

By performing additional training at the data quality machine learning model 310, the performance of the data quality machine learning model 310 may increase over time. The additional training may also allow the user to customize the data quality machine learning model 310 to suit the user's goals for data quality assessment.

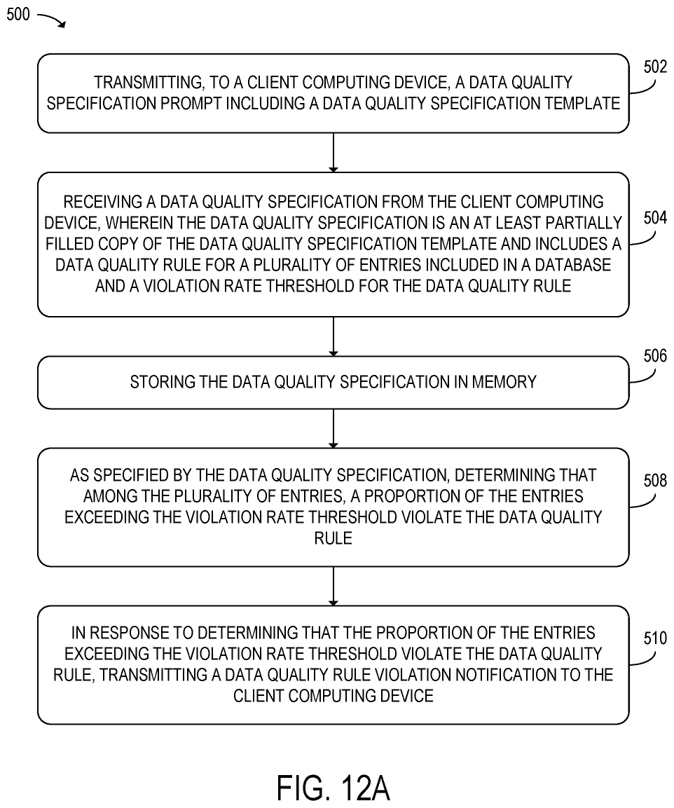

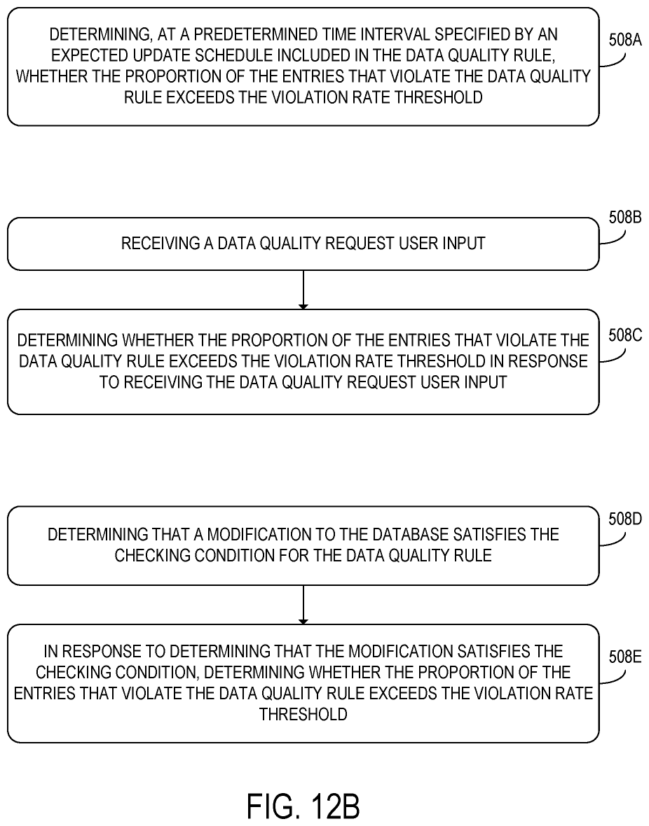

FIG. 12A shows a flowchart of an example method 500 that may be used with a computing system when data quality evaluation is performed. The computing system at which the method 500 is performed may be the computing system 10 of FIG. 2. At step 502, the method 500 may include transmitting, to a client computing device, a data quality specification prompt including a data quality specification template. The data quality specification prompt may include one or more template sentences, which may each include one or more fillable template fields. In some examples, the data quality specification template may include a plurality of template sentences that are configured to be selectable at a GUI of the client computing device. In such examples, the data quality specification may include a filled version of a template sentence of the plurality of template sentences. For example, the filled version of the template sentence may be generated at least in part at a data quality machine learning model.

At step 504, the method 500 may further include receiving a data quality specification from the client computing device. The data quality specification may be an at least partially filled copy of the data quality specification template and may include a data quality rule for a plurality of entries included in a database. For example, the data quality rule may be defined for one or more specific tables included in the database. The data quality specification may include a scope that indicates a portion of the database to which the data quality rule is configured to be applied. The data quality rule may encode a user's standards for properties of the plurality of entries such as completeness, appropriate type, or appropriate range. The data quality rule may, for example, include an expected data type for the plurality of entries, an expected data value range for the plurality of entries, an expected update schedule for the plurality of entries, an expected number of rows of a table that includes the plurality of entries, an expected number of columns of the table that includes the plurality of entries, or an expected file size of the table that includes the plurality of entries. Other types of data quality rules may additionally or alternatively be included in the data quality specification. In some examples, a plurality of data quality rules may be included in the data quality specification.

The data quality specification may further include a violation rate threshold for the data quality rule. The violation rate threshold may be a rate of violation of the data quality rule among the plurality of entries that prompts notification of the user. the violation rate threshold may be included among a plurality of differing violation rate thresholds for the data quality rule that indicate different levels of violation severity. In some examples, additionally or alternatively to the violation rate threshold, the data quality specification may include a violation number threshold, which may be a number of violations of the data quality rule among the plurality of entries that prompts notification of the user.

At step 506, the method 500 may further include storing the data quality specification in memory. Subsequently to storing the data quality specification, the method 500 may further include, at step 508, determining that among the plurality of entries, a proportion of the entries exceeding the violation rate threshold violate the data quality rule, as specified by the data quality specification. At step 510, in response to determining that the proportion of the entries exceeding the violation rate threshold violate the data quality rule, the method 500 may further include transmitting a data quality rule violation notification to the client computing device. Thus, the user may be notified that a violation of the data quality rule has occurred. In examples in which the data quality specification includes a violation number threshold, the method may additionally or alternatively include determining that a number of the entries exceeding the violation number threshold violate the data quality rule. In such examples, the data quality rule violation notification may be transmitted to the client computing device in response to such a determination.

In examples in which the violation rate threshold is included among a plurality of differing violation rate thresholds, the data quality rule violation notification may be selected from among a plurality of data quality rule violation notifications respectively associated with the violation rate thresholds. In such examples, the data quality specification may further include a respective plurality of priority levels of the data quality rule violation notifications associated with the violation rate thresholds. The plurality of priority levels may differ among the plurality of data quality rule violation notifications. For example, the plurality of priority levels may include a “warning” level and an “alert” level that indicate different violation rate levels.

FIG. 12B shows additional steps of the method 500 that may be performed when performing step 508. In some examples, the data quality rule may include an expected update schedule, as discussed above. In such examples, at step 508A, step 508 may include determining, at a predetermined time interval specified by the expected update schedule, whether the proportion of entries that violate the data quality rule exceeds the violation rate threshold.

In some examples, at step 508B, step 508 may include receiving a data quality request user input. In response to receiving the data quality request user input, step 508 may further include, at step 508C, determining whether the proportion of the entries that violate the data quality rule exceeds the violation rate threshold. The plurality of entries may therefore be checked for violations of the data quality rule when requested by the user of the client computing device.

The data quality specification may, in some examples, include a checking condition under which the plurality of entries are configured to be checked for violations of the data quality rule. The checking condition may be an action performed at the database, such as adding or deleting a column or row. At step 508D, step 508 may further include determining that a modification to the database satisfies the checking condition. At step 508E, in response to determining that the modification satisfies the checking condition, step 508 may further include determining whether the proportion of the entries that violate the data quality rule exceeds the violation rate threshold. Accordingly, the plurality of entries may be checked for violations of the data quality rule when an action is performed at the database that may lead to violations.

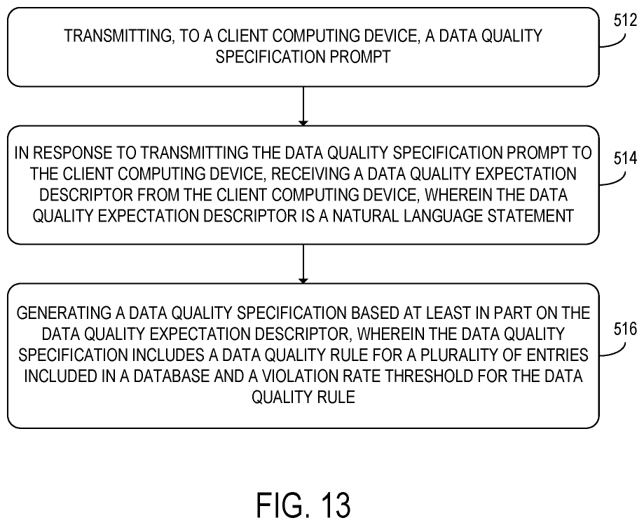

FIG. 13 shows alternative steps to steps 502 and 504 of the method 500 that may be performed when the data quality specification is generated, according to one example. At step 512, the method 500 may include transmitting, to the client computing device, a data quality specification prompt. The data quality specification prompt may be a prompt for the user of the client computing device to enter one or more data quality expectations from which the data quality specification is configured to be generated. The data quality specification prompt may be a prompt for natural language input.

At step 514, in response to transmitting the data quality specification prompt to the client computing device, the method 500 may further include receiving a data quality expectation descriptor from the client computing device. The data quality expectation descriptor may be a natural language statement describing the user's data quality standard for the plurality of entries.

At step 516, the method 500 may further include generating a data quality specification based at least in part on the data quality expectation descriptor. The data quality specification may include a data quality rule for a plurality of entries included in a database and may further include a violation rate threshold for the data quality rule. Thus, the data quality specification may, in the example of FIG. 13, be generated from a natural language statement rather than from a fillable template.

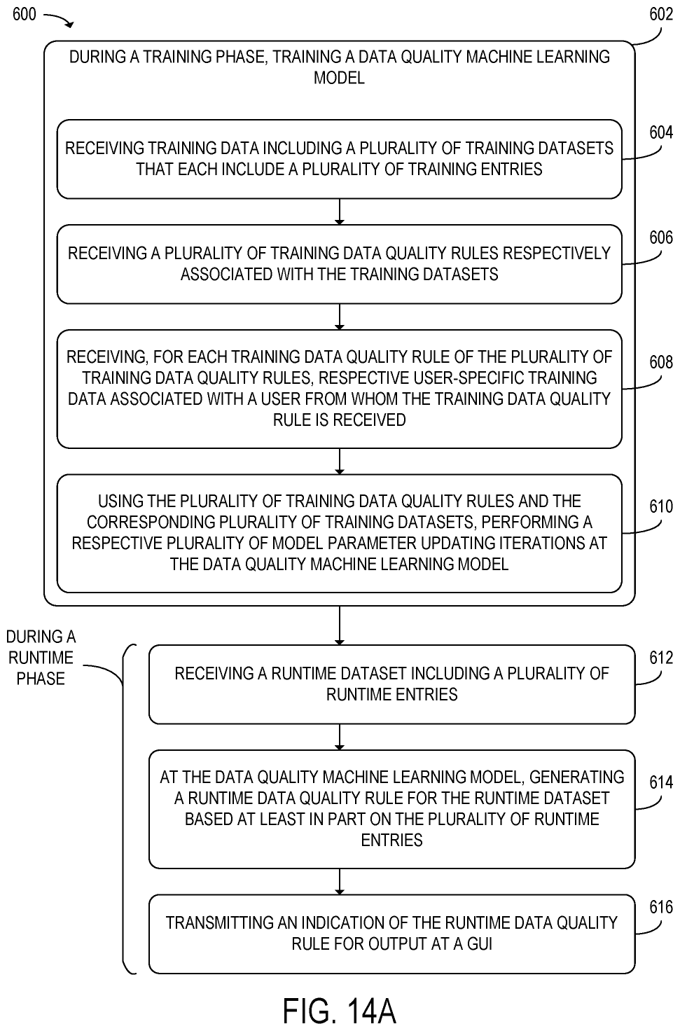

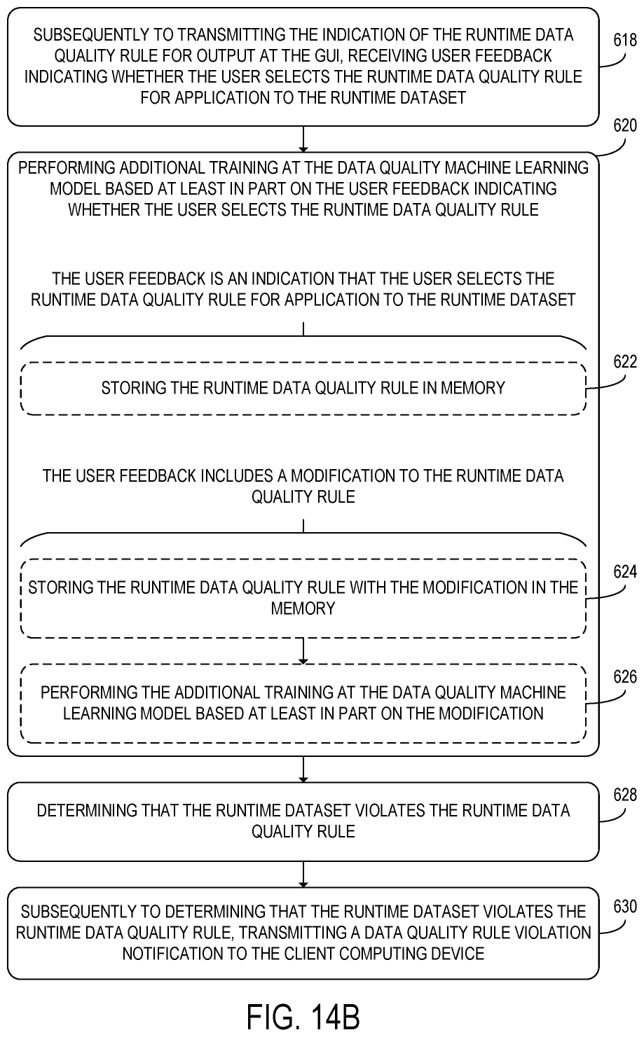

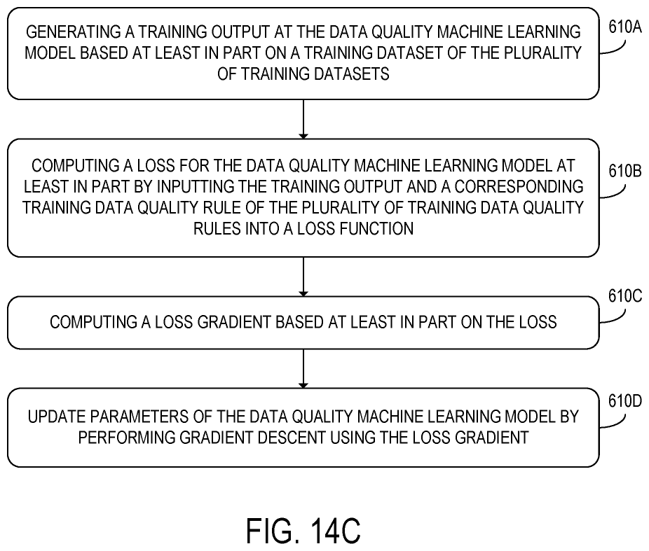

FIG. 14A shows a flowchart of an example method 600 that may be used with a computing system when training and executing a data quality machine learning model. The method may include, at step 602, training the data quality machine learning model during a training phase. Training the data quality machine learning model during the training phase may include, at step 604, receiving training data including a plurality of training datasets that each include a plurality of training entries.

Training the data quality machine learning model may further include, at step 606, receiving a plurality of training data quality rules respectively associated with the training datasets. In some examples, the plurality of training data quality rules may be received in a plurality of training data quality specifications, each of which may include one or more of the training data quality rules. The training data quality specifications may each further include additional data such as one or more training tags, one or more training violation rate thresholds, one or more training violation number thresholds, one or more training checking conditions, and/or one or more training priority levels. Other types of additional data may be included in the training data quality specifications in some examples.

In some examples, at step 608, training the data quality machine learning model may further include receiving, for each training data quality rule of the plurality of training data quality rules, respective user-specific training data associated with a user from whom the training data quality rule is received. The user-specific training data may include database use history of the user and/or a user role indicator of the user within an organization.

At step 610, the method 600 may further include performing a respective plurality of model parameter updating iterations at the data quality machine learning model using the plurality of training data quality rules and the corresponding plurality of training datasets. Thus, the data quality machine learning model may be trained over the plurality of model parameter updating iterations.

Steps 612, 614, and 616 of the method 600 may be performed during a runtime phase. At step 612, the method 600 may further include receiving a runtime dataset including a plurality of runtime entries. The plurality of runtime entries may be the plurality of entries included in the database discussed above and may be received from a client computing device. Alternatively, the plurality of runtime entries may be stored at another computing device to which the client computing device may instruct the computing system to perform one or more database queries. In examples in which the training data includes user-specific training data, user-specific runtime data may also be received during the runtime phase.

At step 614, the method 600 may further include, at the data quality machine learning model, generating a runtime data quality rule for the runtime dataset based at least in part on the plurality of runtime entries. In some examples, the data quality machine learning model may include a classifier configured to select a data quality rule template for the runtime data quality rule from among a plurality of data quality rule templates. In such examples, the data quality machine learning model may further include a template value field recommendation module configured to generated values with which to fill one or more fillable template fields included in the selected template. The runtime data quality rule may, for example, include an expected data type for the plurality of runtime entries, an expected data value range for the plurality of runtime entries, an expected update schedule for the plurality of runtime entries, an expected number of rows of a table that includes the plurality of runtime entries, an expected number of columns of the table that includes the plurality of runtime entries, or an expected file size of the table that includes the plurality of runtime entries.

At step 616, the method 600 may further include transmitting an indication of the runtime data quality rule for output at a GUI. The GUI may be a GUI displayed at the client computing device from which the runtime dataset is received. As discussed above, the indication of the runtime data quality rule may be a data quality specification template. The data quality specification template may include one or more fillable template fields, which may be at least partially filled in examples in which the data quality machine learning model includes a template value field recommendation module. The user of the client computing device may, by interacting with the GUI, fill the one or more fillable template fields and/or modify the values of one or more programmatically filled template fields.

In some examples, step 614 may include generating a plurality of runtime data quality rules including the runtime data quality rule. In such examples, when step 616 is performed, the runtime data quality rule may be included in a ranked data quality rule list of the plurality of runtime data quality rules that is transmitted for output at the GUI. The user may select one or more of the runtime data quality rules to apply to the plurality of runtime entries. Accordingly, the data quality machine learning model may assist the user in defining a runtime data quality rule for the runtime dataset.

FIG. 14B shows additional steps of the method 600 that may be performed during the runtime phase in some examples. At step 618, the method 600 may further include, subsequently to transmitting the indication of the runtime data quality rule for output at the GUI, receiving user feedback indicating whether the user selects the runtime data quality rule for application to the runtime dataset. The user may select the runtime data quality rule generated at the data quality machine learning model for application to the runtime dataset with no changes or may alternatively modify the runtime data quality rule at the GUI before instructing the computing system to apply the runtime data quality rule. As another potential action taken by the user, the user may reject the recommended runtime data quality rule and instead manually specify a runtime data quality rule at the GUI.

At step 620, the method 600 may further include performing additional training at the data quality machine learning model based at least in part on the user feedback indicating whether the user selects the runtime data quality rule. For example, the additional training may be performed via reinforcement learning. In such examples, a reward may be computed for the data quality machine learning model based at least in part on the user feedback.

In examples in which the user feedback is an indication that the user selects the runtime data quality rule for application to the runtime dataset, step 620 may further include, at step 624, storing the runtime data quality rule in memory. When the user feedback includes a modification to the runtime data quality rule, step 620 may further include storing the runtime data quality rule with the modification in the memory. A runtime data quality rules that is rejected by the user may instead be deleted. In examples in which the user feedback includes a modification, step 620 may further include performing the additional training at the data quality machine learning model based at least in part on the modification. Thus, the feedback provided to the data quality machine learning model during the additional training may include information that is more detailed than an indication of acceptance or rejection of the runtime data quality rule.

In examples in which the user selects the runtime data quality rule for application to the runtime dataset, either with or without modification, the method 600 may further include, at step 628, determining that the runtime dataset violates the runtime data quality rule. Subsequently to determining that the runtime dataset violates the runtime data quality rule, the method 600 may further include, at step 630, transmitting a data quality rule violation notification to the client computing device.

FIG. 14C shows additional steps of the method 600 that may be performed in some examples during each model parameter updating iteration performed during step 610. At step 610A, performing each of the model parameter updating iterations may include generating a training output a training output at the data quality machine learning model based at least in part on a training dataset of the plurality of training datasets. At step 610B, step 610 may further include computing a loss for the data quality machine learning model a loss for the data quality machine learning model at least in part by inputting the training output and a corresponding training data quality rule of the plurality of training data quality rules into a loss function. At step 610C, step 610 may further include computing a loss gradient for the data quality machine learning model based at least in part on the loss. At step 610D, step 610 may further include updating parameters of the data quality machine learning model by performing gradient descent using the loss gradient.

According to one example use case scenario, the database stores data pertaining to airplane flights provided by an airline. Multiple different teams of users within the airline use the database, and the different teams have different sets of data quality expectations. When a new team of users begins using the database, the computing system accesses user-specific runtime data that indicates the roles of the members of the new team within the airline. The computing system then recommends data quality rules to the members of the new team by classifying the new team at the data quality machine learning model according to the user-specific runtime data of its members. The computing system, in this example, selects a data quality specification template used by a previous team with a role in the organization that is closest to that of the new team. In this example, the new team is an aircraft maintenance scheduling team, and the previous team is a flight scheduling team.

The values with which the computing system fills the fillable template fields included in that template are also generated based in part on the user-specific runtime data of the users included in the new team. The computing system, in this example, determines from the database use history of the users included in the new team that the users included in the aircraft maintenance scheduling team query the database less frequently on average than the users in the flight scheduling team. The computing system may accordingly set the expected update schedule for the aircraft maintenance scheduling team to be less frequent than the expected update schedule for the flight scheduling team.

In this example, the computing system transmits a programmatically filled template to a member of the aircraft maintenance scheduling team for display at a GUI of a computing device used by that user. At the GUI, the user adjusts the values in the filled template fields before instructing the computing system to apply the resulting data quality rule. The computing system then stores a data quality specification including the modified data quality rule in memory. In addition, the computing system performs additional training at the data quality machine learning model subsequently to the user selecting and modifying the data quality rule.

At the predetermined time interval specified in the data quality rule, the computing system determines a proportion of entries in a portion of the database that violate the data quality rule. In this example, a table included in the database in this example includes a column of airport codes, and the computing system determines a proportion of the entries in the column that are not valid airport codes. When this proportion is above a violation rate threshold indicated in the data quality specification, the computing system transmits a data quality rule violation notification to a member of the aircraft maintenance scheduling team.

Using the systems and methods discussed above, a user of a database may define data quality expectations for the data included in the database without having to use a domain-specific language or a specialized query building interface. The computing system may also recommend data quality rules that may be adjusted by the user. Accordingly, the systems and methods discussed above may allow users to set data quality rules more quickly and easily and may allow a wider range of users to define their data quality expectations.

In some embodiments, the methods and processes described herein may be tied to a computing system of one or more computing devices. In particular, such methods and processes may be implemented as a computer-application program or service, an application-programming interface (API), a library, and/or other computer-program product.

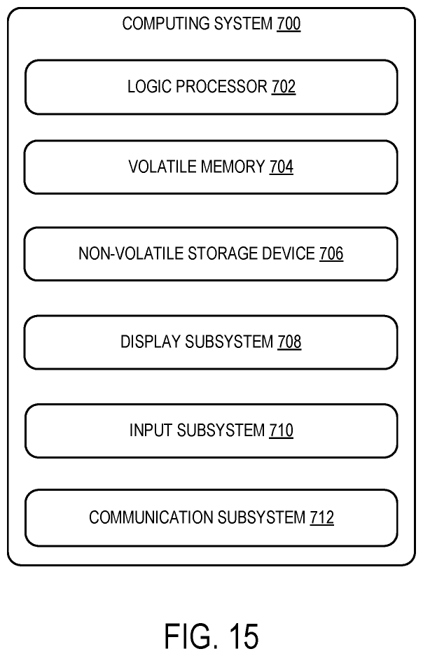

FIG. 15 schematically shows a non-limiting embodiment of a computing system 700 that can enact one or more of the methods and processes described above. Computing system 700 is shown in simplified form. Computing system 700 may embody the computing system 10 described above and illustrated in FIG. 2. One or more components of the computing system 700 may be included in one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 700 includes a logic processor 702 volatile memory 704, and a non-volatile storage device 706. Computing system 700 may optionally include a display subsystem 708, input subsystem 710, communication subsystem 712, and/or other components not shown in FIG. 15.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the logic processors to implement the methods and processes described herein. When such methods and processes are implemented, the state of non-volatile storage device 706 may be transformed—e.g., to hold different data.

Non-volatile storage device 706 may include physical devices that are removable and/or built-in. Non-volatile storage device 706 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via logic processor 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 700 to send and/or receive messages to and/or from other devices via a network such as the Internet.

The following paragraphs discuss several aspects of the present disclosure. According to one aspect of the present disclosure, a computing system is provided, including a processor configured to transmit, to a client computing device, a data quality specification prompt including a data quality specification template. The processor may be further configured to receive a data quality specification from the client computing device. The data quality specification may be an at least partially filled copy of the data quality specification template and may includes a data quality rule for a plurality of entries included in a database. The data quality specification may further include a violation rate threshold for the data quality rule. The processor may be further configured to store the data quality specification in memory. As specified by the data quality specification, the processor may be further configured to determine that among the plurality of entries, a proportion of the entries exceeding the violation rate threshold violate the data quality rule. In response to determining that the proportion of the entries exceeding the violation rate threshold violate the data quality rule, the processor may be further configured to transmit a data quality rule violation notification to the client computing device.

According to this aspect, the data quality rule may include an expected data type for the plurality of entries, an expected data value range for the plurality of entries, an expected update schedule for the plurality of entries, an expected number of rows of a table that includes the plurality of entries, an expected number of columns of the table that includes the plurality of entries, or an expected file size of the table that includes the plurality of entries.

According to this aspect, the data quality rule may include an expected update schedule. The processor may be configured to determine, at a predetermined time interval specified by the expected update schedule, whether the proportion of the entries that violate the data quality rule exceeds the violation rate threshold.

According to this aspect, the violation rate threshold may be included among a plurality of differing violation rate thresholds. The data quality rule violation notification may be selected from among a plurality of data quality rule violation notifications respectively associated with the violation rate thresholds.

According to this aspect, the data quality specification may further include a respective plurality of priority levels of the data quality rule violation notifications associated with the violation rate thresholds. The plurality of priority levels may differ among the plurality of data quality rule violation notifications.

According to this aspect, the processor may be further configured to receive a data quality request user input. The processor may be further configured to determine whether the proportion of the entries that violate the data quality rule exceeds the violation rate threshold in response to receiving the data quality request user input.

According to this aspect, the data quality specification may further include a checking condition for the data quality rule. The processor may be further configured to determine that a modification to the database satisfies the checking condition. In response to determining that the modification satisfies the checking condition, the processor may be further configured to determine whether the proportion of the entries that violate the data quality rule exceeds the violation rate threshold.

According to this aspect, the data quality specification may further include a scope of the data quality rule that indicates a subset of the database for which the processor is configured to determine whether the proportion of the entries that violate the data quality rule exceeds the violation rate threshold.

According to this aspect, the data quality specification template may be configured to be displayed at a graphical user interface (GUI) of the client computing device.

According to this aspect, the data quality specification template may include a plurality of template sentences that are configured to be selectable at the GUI of the client computing device. The data quality specification may include a filled version of a template sentence of the plurality of template sentences.

According to this aspect, the processor may be further configured to receive a plurality of data quality specifications that each include one or more tags. The processor may be further configured to receive, from the client computing device, a selection of a tag of the one or more tags. In response to receiving the selection of the tag, the processor may be further configured to determine, for each of the plurality of data quality specifications that have the selected tag, whether the proportion of the entries that violate the data quality rule for that data quality specification exceeds the violation rate threshold for that data quality rule.

According to another aspect of the present disclosure, a method for use with a computing system is provided. The method may include transmitting, to a client computing device, a data quality specification prompt including a data quality specification template. The method may further include receiving a data quality specification from the client computing device. The data quality specification may be an at least partially filled copy of the data quality specification template and may includes a data quality rule for a plurality of entries included in a database. The data quality specification may further include a violation rate threshold for the data quality rule. The method may further include storing the data quality specification in memory. The method may further include, as specified by the data quality specification, determining that among the plurality of entries, a proportion of the entries exceeding the violation rate threshold violate the data quality rule. The method may further include, in response to determining that the proportion of the entries exceeding the violation rate threshold violate the data quality rule, transmitting a data quality rule violation notification to the client computing device.

According to this aspect, the data quality rule may include an expected data type for the plurality of entries, an expected data value range for the plurality of entries, an expected update schedule for the plurality of entries, an expected number of rows of a table that includes the plurality of entries, an expected number of columns of the table that includes the plurality of entries, or an expected file size of the table that includes the plurality of entries.

According to this aspect, the violation rate threshold may be included among a plurality of differing violation rate thresholds. The data quality rule violation notification may be selected from among a plurality of data quality rule violation notifications respectively associated with the violation rate thresholds. The data quality specification may further include a respective plurality of priority levels of the data quality rule violation notifications associated with the violation rate thresholds. The plurality of priority levels may differ among the plurality of data quality rule violation notifications.

According to this aspect, the method may further include receiving a data quality request user input. The method may further include determining whether the proportion of the entries that violate the data quality rule exceeds the violation rate threshold in response to receiving the data quality request user input.

According to this aspect, the data quality specification may further include a checking condition for the data quality rule. The method may further include determining that a modification to the database satisfies the checking condition. The method may further include, in response to determining that the modification satisfies the checking condition, determining whether the proportion of the entries that violate the data quality rule exceeds the violation rate threshold.

According to this aspect, the data quality specification may further include a scope of the data quality rule that indicates a subset of the database for which the proportion of the entries exceeding the violation rate threshold is determined.

According to this aspect, the data quality specification template may be configured to be displayed at a graphical user interface (GUI) of the client computing device.

According to this aspect, the data quality specification template may include a plurality of template sentences that are configured to be selectable at the GUI of the client computing device. The data quality specification may include a filled version of a template sentence of the plurality of template sentences.

According to another aspect of the present disclosure, a computing system is provided, including a processor configured to transmit, to a client computing device, a data quality specification prompt. In response to transmitting the data quality specification prompt to the client computing device, the processor may be further configured to receive a data quality expectation descriptor from the client computing device. The data quality expectation descriptor may be a natural language statement. The processor may be further configured to generate a data quality specification based at least in part on the data quality expectation descriptor. The data quality specification may include a data quality rule for a plurality of entries included in a database. The data quality specification may further include a violation rate threshold for the data quality rule. The processor may be further configured to store the data quality specification in memory. As specified by the data quality specification, the processor may be further configured to determine that among the plurality of entries, a proportion of the entries exceeding the violation rate threshold violate the data quality rule. In response to determining that the proportion of the entries exceeding the violation rate threshold violate the data quality rule, the processor may be further configured to transmit a data quality rule violation notification to the client computing device.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
a processor configured to:
transmit, to a client computing device, a data quality specification prompt including a data quality specification template;
receive a data quality specification from the client computing device, wherein the data quality specification is an at least partially filled copy of the data quality specification template and includes:
a data quality rule for a plurality of entries included in a database; and
a violation rate threshold for the data quality rule;
store the data quality specification in memory;
as specified by the data quality specification, determine that among the plurality of entries, a proportion of the entries exceeding the violation rate threshold violate the data quality rule; and
in response to determining that the proportion of the entries exceeding the violation rate threshold violate the data quality rule, transmit a data quality rule violation notification to the client computing device.

2. The computing system of claim 1, wherein the data quality rule includes an expected data type for the plurality of entries, an expected data value range for the plurality of entries, an expected update schedule for the plurality of entries, an expected number of rows of a table that includes the plurality of entries, an expected number of columns of the table that includes the plurality of entries, or an expected file size of the table that includes the plurality of entries.

3. The computing system of claim 2, wherein:
the data quality rule includes an expected update schedule; and
the processor is configured to determine, at a predetermined time interval specified by the expected update schedule, whether the proportion of the entries that violate the data quality rule exceeds the violation rate threshold.

4. The computing system of claim 1, wherein:
the violation rate threshold is included among a plurality of differing violation rate thresholds; and
the data quality rule violation notification is selected from among a plurality of data quality rule violation notifications respectively associated with the violation rate thresholds.

5. The computing system of claim 4, wherein:
the data quality specification further includes a respective plurality of priority levels of the data quality rule violation notifications associated with the violation rate thresholds; and
the plurality of priority levels differ among the plurality of data quality rule violation notifications.

6. The computing system of claim 1, wherein the processor is further configured to:
receive a data quality request user input; and
determine whether the proportion of the entries that violate the data quality rule exceeds the violation rate threshold in response to receiving the data quality request user input.

7. The computing system of claim 1, wherein:
the data quality specification further includes a checking condition for the data quality rule; and
the processor is further configured to:
determine that a modification to the database satisfies the checking condition; and
in response to determining that the modification satisfies the checking condition, determine whether the proportion of the entries that violate the data quality rule exceeds the violation rate threshold.

8. The computing system of claim 1, wherein the data quality specification further includes a scope of the data quality rule that indicates a subset of the database for which the processor is configured to determine whether the proportion of the entries that violate the data quality rule exceeds the violation rate threshold.

9. The computing system of claim 1, wherein the data quality specification template is configured to be displayed at a graphical user interface (GUI) of the client computing device.

10. The computing system of claim 9, wherein:
the data quality specification template includes a plurality of template sentences that are configured to be selectable at the GUI of the client computing device; and
the data quality specification includes a filled version of a template sentence of the plurality of template sentences.

11. The computing system of claim 1, wherein the processor is further configured to:
receive a plurality of data quality specifications that each include one or more tags;
receive, from the client computing device, a selection of a tag of the one or more tags; and
in response to receiving the selection of the tag, determine, for each of the plurality of data quality specifications that have the selected tag, whether the proportion of the entries that violate the data quality rule for that data quality specification exceeds the violation rate threshold for that data quality rule.

12. A method for use with a computing system, the method comprising:
transmitting, to a client computing device, a data quality specification prompt including a data quality specification template;
receiving a data quality specification from the client computing device, wherein the data quality specification is an at least partially filled copy of the data quality specification template and includes:
a data quality rule for a plurality of entries included in a database; and
a violation rate threshold for the data quality rule;
storing the data quality specification in memory;
as specified by the data quality specification, determining that among the plurality of entries, a proportion of the entries exceeding the violation rate threshold violate the data quality rule; and
in response to determining that the proportion of the entries exceeding the violation rate threshold violate the data quality rule, transmitting a data quality rule violation notification to the client computing device.

13. The method of claim 12, wherein the data quality rule includes an expected data type for the plurality of entries, an expected data value range for the plurality of entries, an expected update schedule for the plurality of entries, an expected number of rows of a table that includes the plurality of entries, an expected number of columns of the table that includes the plurality of entries, or an expected file size of the table that includes the plurality of entries.

14. The method of claim 12, wherein:
the violation rate threshold is included among a plurality of differing violation rate thresholds;
the data quality rule violation notification is selected from among a plurality of data quality rule violation notifications respectively associated with the violation rate thresholds;
the data quality specification further includes a respective plurality of priority levels of the data quality rule violation notifications associated with the violation rate thresholds; and
the plurality of priority levels differ among the plurality of data quality rule violation notifications.

15. The method of claim 12, further comprising:
receiving a data quality request user input; and
determining whether the proportion of the entries that violate the data quality rule exceeds the violation rate threshold in response to receiving the data quality request user input.

16. The method of claim 11, wherein:
the data quality specification further includes a checking condition for the data quality rule; and
the method further comprises:
determining that a modification to the database satisfies the checking condition; and
in response to determining that the modification satisfies the checking condition, determining whether the proportion of the entries that violate the data quality rule exceeds the violation rate threshold.

17. The method of claim 11, wherein the data quality specification further includes a scope of the data quality rule that indicates a subset of the database for which the proportion of the entries exceeding the violation rate threshold is determined.

18. The method of claim 11, wherein the data quality specification template is configured to be displayed at a graphical user interface (GUI) of the client computing device.

19. The method of claim 18, wherein:
the data quality specification template includes a plurality of template sentences that are configured to be selectable at the GUI of the client computing device; and
the data quality specification includes a filled version of a template sentence of the plurality of template sentences.

20. A computing system comprising:
a processor configured to:
transmit, to a client computing device, a data quality specification prompt;
in response to transmitting the data quality specification prompt to the client computing device, receive a data quality expectation descriptor from the client computing device, wherein the data quality expectation descriptor is a natural language statement;
generate a data quality specification based at least in part on the data quality expectation descriptor, wherein the data quality specification includes:
a data quality rule for a plurality of entries included in a database; and
a violation rate threshold for the data quality rule;
store the data quality specification in memory;
as specified by the data quality specification, determine that among the plurality of entries, a proportion of the entries exceeding the violation rate threshold violate the data quality rule; and
in response to determining that the proportion of the entries exceeding the violation rate threshold violate the data quality rule, transmit a data quality rule violation notification to the client computing device.
